(19) United States
(12) Patent Application Publication
(10) Pub. No.: US 2006/0289680 A1
(43) Pub. Date: Dec. 28, 2006

(54) SHOWER

(75) Inventor: Chung-I Huang, Ho Mei Town (TW)

Correspondence Address: NIKOLAI & MERSEREAU, P.A., 900 SECOND AVENUE SOUTH, SUITE 820, MINNEAPOLIS, MN, 55402, US

(73) Assignees: Chung-I Huang, Ho Mei Town (TW); Chung-Yu Hsieh, Ho Mei Town (TW)

(21) Appl. No.: 11/160,411

(22) Filed: Jun. 22, 2005

(51) Int. Cl. A62C 31/00

(52) U.S. Cl. 239/445; 239/588; 239/583; 239/443

(57) ABSTRACT

There is disclosed a shower apparatus including a shower, an outlet device and a control device. The shower includes a handle defining a passageway and a head defining a space in communication with the passageway and a recess in communication with the space. The outlet device is put in the space and can be switched between a closed position and an open position and kept in the open position as long as water keeps coming. The control device extends into the space from the recess so that it can be operated in order to switch the outlet device to the open position from the closed position.

### BACKGROUND OF INVENTION

1. Field of Invention

The present invention relates to a shower.

2. Related Prior Art

According to Taiwanese Patent No. 520016, “Bifurcation Device of a Tap”, a tap 1 includes a first outlet 12, a valve housing 2 put therein, a bifurcation device 3 movably put in the valve housing 2, a second outlet 4, a shower 5 connected to the second outlet 4 through a flexible pipe, and a base 6 attached thereto. The tap 1 includes a handle 11 operable in order to switch the tap 1 between a closed position and an open position. The shower 5 includes a handle 51 operable in order to switch the shower 5 between a closed position and an open position. When the tap 1 is in the closed position, water is blocked from the tap 1. Hence, no water comes out from the first output element 4. When the tap 1 is in the open position, water is allowed to enter the tap 1. Now, if the shower 5 is in the closed position, the water comes out from the first outlet element 12 because of the bifurcation device 3. If the shower 5 is in the open position, the water comes out from the shower 5 instead of the first outlet 12 because of the bifurcation device 3. However, a user must keep the handle 51 in the open position with one hand or the water stops coming from the shower 5. Hence, the user has only one hand left for other tasks that may require two hands. Obviously, the operation of this conventional tap 1 is not satisfactory.

The present invention is therefore intended to obviate or at least alleviate the problems encountered in prior art.

### SUMMARY OF INVENTION

According to the present invention, a shower apparatus includes a shower, an outlet device and a control device. The shower includes a handle defining a passageway and a head defining a space in communication with the passageway and a recess in communication with the space. The outlet device is put in the space and can be switched between a closed position and an open position and kept in the open position as long as water keeps coming. The control device extends into the space from the recess so that it can be operated in order to switch the outlet device to the open position from the closed position.

The primary advantage of the shower apparatus according to the present invention is the hand-free use thereof after it is switched to the open position.

Other advantages and novel features of the invention will become more apparent from the following detailed description in conjunction with the drawings.

### BRIEF DESCRIPTION OF DRAWINGS

The present invention will be described through detailed illustration of embodiments referring to the drawings.

FIG. 1 is a perspective view of a tap/shower assembly according to a first embodiment of the present invention.

FIG. 2 is an exploded view of a tap of the tap/shower assembly shown in FIG. 1.

FIG. 3 is a cut-away view of the tap shown in FIG. 1.

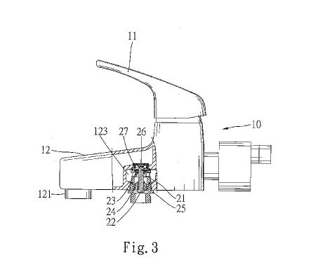

FIG. 4 is similar to FIG. 3 but shows water coming out from a first outlet of the tap.

FIG. 5 is similar to FIG. 4 but shows water coming out from a second outlet of the tap.

FIG. 6 is an exploded view of a shower of the tap/shower assembly shown in FIG. 1.

FIG. 7 is a cross-sectional view of the shower shown in FIG. 6.

FIG. 8 is similar to FIG. 7 but shows a button pressed in order to switch the shower to an open position.

FIG. 9 is similar to FIG. 8 but shows the button released, yet leaving the shower in the open position so that water continues to come out from the shower.

FIG. 10 is a perspective view of a tap according to a second embodiment of the present invention.

FIG. 11 is an exploded view of a shower of the tap/shower assembly shown in FIG. 10.

FIG. 12 is a cross-sectional view of the shower shown in FIG. 11.

FIG. 13 is similar to FIG. 12 but shows a first button pressed in order to switch the shower to an open position.

FIG. 14 is similar to FIG. 13 but shows the first button released, yet leaving the shower in the open position so that water continues to come out from the shower.

FIG. 15 is similar to FIG. 14 but shows a second button pressed in order to switch the shower to a closed position.

### DETAILED DESCRIPTION OF EMBODIMENTS

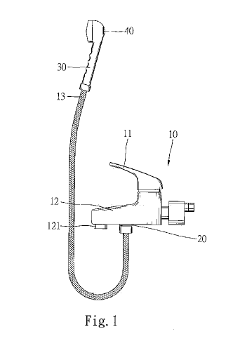

Referring to FIG. 1, according to a first embodiment of the present invention, a tap/shower assembly includes a tap 10, a shower 30, and a bifurcation device 20. The tap 10 includes an inlet (not shown) and an outlet element 12 that includes a first outlet 121 and a second output 122. The shower 30 is communicated with the second outlet 122 through a flexible pipe 13. The bifurcation device 20 is put in a space 123 communicated with the second output 122.

When the tap 10 is in a closed position, water is not allowed into the tap 10 through the inlet. Hence, no water comes out from the first outlet 121 or the shower 30. When the tap 10 is in an open position, water is allowed into the tap 10 through the inlet. Now, if the shower 30 is in a closed position, the water will come out from the first outlet 121 because of the bifurcation device 20. If the shower 30 is in an open position, the water will come out from the shower 30 instead of the first outlet 121 because of the bifurcation device 20.

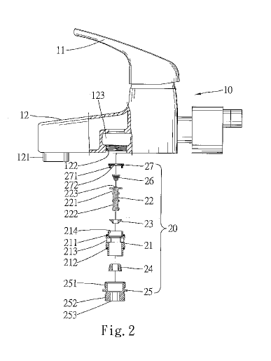

Referring to FIG. 2, the tap 10 includes a handle 11 that can be operated in order to switch the tap 10 between the closed position and the open position.

The bifurcation device 20 includes a housing 21, a core 22, a first valve 23, a second valve 24, a fastener 25, a spring 26, and a cap 27.

The housing 21 includes an upper section, a lower section, and a middle section. A seal 211 is put around the upper section of the housing 21. A seal 212 is put around the lower section of the housing 21. A plurality of apertures 213 is defined in the middle section of the housing 21. A plurality of recesses 214 is defined in an internal side of the upper section.

The core 22 includes a first groove 221 defined in the periphery thereof, a second groove 222 defined in the periphery thereof, and a boss 223 formed at an end.

The first valve 23 is put in the first groove 221 of the core 22 before the core 22 is inserted in the housing 21. The first valve 23 is put in the first section of the housing 21. The second valve 24 is put in the second groove 222. The second valve 24 is put in the second section of the housing 21. The spring 26 is put on the core 22. The boss 223 of the core 22 is inserted in the spring 26.

The cap 27 includes a plurality of hooks 271 formed on the bottom thereof and a recess 272 defined in the bottom thereof. The hooks 271 are put in the recesses 214 of the housing 21. Thus, the cap 27 is connected to the housing 21. Hence, the core 22, the first valve 23 and the second valve 24 are kept in the housing 21. The recess 272 receives an end of the spring 26.

The bifurcation device 20 except the fastener 25 is put and concealed in the space 123. This is aesthetically pleasing. No additional hole has to be made in the tap 10.

The fastener 25 includes a first thread 251 formed on the periphery thereof, a second thread 252 formed on the periphery thereof, and a hexangular hole 253 defined therein. The first thread 251 is engaged with a thread formed on the wall of the second outlet 122. Thus, the fastener 25 is connected to the tap 10. Hence, the entire bifurcation device 20 is kept in the tape 10. A second thread 252 of the fastener 25 can be engaged with a thread formed on an internal side of a ring (not shown) rotationally connected to an end of the flexible pipe 13. Thus, the shower 30 is connected to the bifurcation device 20.

In the case that the tap 10 is blocked by impurities, the fastener 25 can be disengaged from the tap 10, and the entire bifurcation device 20 moved from the tap 10, and dissembled and cleaned and re-assembled or simply replaced. The maintenance, repair and replacement of the bifurcation device 20 are convenient and save a lot of time.

The shower 30 is equipped with a control device 40 that is operable in order to switch the shower 30 between the closed position and the open position.

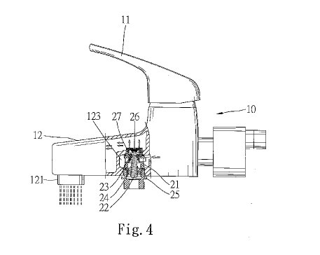

Referring to FIGS. 1 and 4, the tap 10 is in the open position, and the shower 30 in the closed position. The water from the inlet pushes open and flows past the first valve 23, and finally comes out from the first outlet 121. The water cannot push open the second valve 24 as it is encountered by water in the flexible pipe 13.

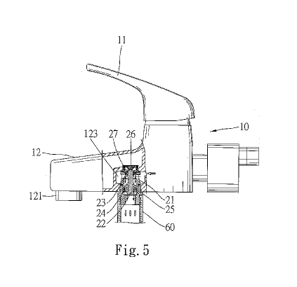

Referring to FIGS. 1 and 5, the tap 10 is still in the open position, and the shower 30 in the open position. As not encountered by the water in the flexible pipe 13, the water pushes open and flows past the second valve 24, and finally comes out from the shower 30 instead of the first outlet 121. As the second valve 24 opens the lower section of the housing 21, the first valve 23 blocks the upper section of the housing 21.

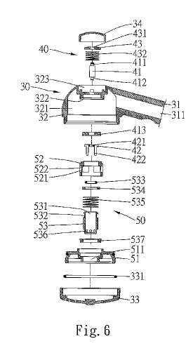

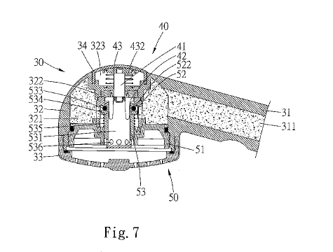

Referring to FIGS. 6 and 7, the shower 30 includes a handle 31 and a head 32. The handle 31 defines a passageway 311 communicated with the second outlet 122 of the tap 10. The head 32 defines a space 321 communicated with the passageway 311 of the handle 31 and a recess 323 communicated with the space 321. An annular ridge 322 is formed on the ceiling of the space 321. Moreover, the shower 30 includes a flexible cover 34 and a rigid porous cover 33. The covers 33 and 34 will be described later.

The control device 40 includes a rod 41, a pusher 42, and a button 43. The rod 41 includes a first end 411 and a second end 412. The rod 41 is inserted in an aperture (not numbered) that communicates the space 321 with the recess 323. The first end 411 of the rod 41 is put in the recess 323, and the second end 412 in the space 321.

A spring 432 is put around the first end 411 of the rod 41. The button 43 defines a hole 431 in which the first end 411 of the rod 41 is fit. The spring 432 is compressed between the button 43 and the head 32.

The flexible cover 34 is put in the recess 323 in order to protect the button 43, the spring 432 and the rod 41.

A seal 413 is put between the rod 41 and the annular ridge 322. The pusher 42 includes a hole 431 in which the second end 412 of the rod 41 is fit and a pushing portion 422.

An outlet device 50 includes a seat 51, a cage 52 and a valve 53. The seat 51 defines an aperture 511 in the form of a countersink hole. A seal 537 is put in the aperture 511.

The valve 53 defines a passageway 531, a plurality of apertures 536 communicated with the passageway 531 and a groove 532 in the periphery thereof. The valve 53 is inserted in the seat 51 and the seal 537. A ring 534 and a seal 533 are put in the groove 532.

The cage 52 defines a passageway (not numbered) and a plurality of apertures 521 communicated with the passageway. A shoulder 522 is formed on the wall of the passageway. The cage 52 is put on the valve 53. A spring 535 is compressed between the shoulder 522 and the ring 534.

The porous cover 33 is connected to the head 32. Thus, the outlet device 50 is kept in the head 32. A seal 331 is provided between the head 32 and the cover 33.

Referring to FIGS. 1 and 7, when the tap 10 is in the open position, the water from the inlet thereof flows to the space 321 of the head 32 through the passageway 311. The spring 535 pushes the ring 534 upwards so that the seal 533 contacts the shoulder 522. Thus, the water can only come out from the first outlet 121.

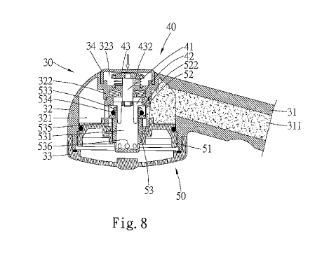

Referring to FIGS. 1 and 8, the button 43 is pressed. The pusher 42 is moved downwards. The pusher 42 pushes the valve 53 downwards. A gap occurs between the seal 533 and the shoulder 522. The water flows into the passageway 531 and thus pushes the valve 53 downwards. The water flows into a portion of the space 321 below the seat from the passageway 531 through the apertures 536. Through apertures (not numbered) defined in the porous cover 33, the water comes out from the head 32 of the shower 30 instead of the first outlet 121 of the tap 10.

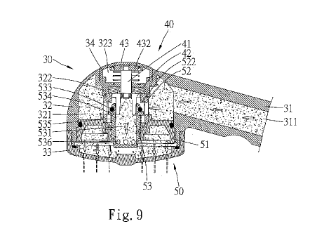

Referring to FIGS. 1 and 9, after the water starts to come out from the head 32 of the shower 30, the button 43 is released. The water continues to come out from the head 32 of the shower 30. A user can put the shower 30 on a holder (not shown) mounted on a wall (not shown). The user's hands are available for other tasks. This is convenient.

To stop the water, the user simply turns the tap 10 to the closed position by means of operating the handle 11. As water stops pushing the valve 53, the spring 535 pushes the ring 534 upwards. Accordingly, the seal 533 is moved upwards in order to contact the shoulder 522.

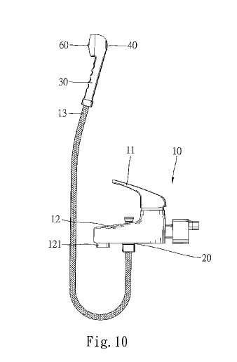

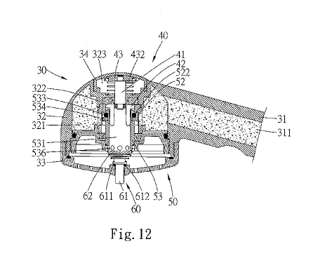

FIGS. 10 through 12 show a shower 30 according to a second embodiment of the present invention. The second embodiment is similar to the first embodiment except including a second button 60 that can be pushed in order to push the ring 534 upwards. Accordingly, the seal 533 is moved upwards in order to contact the shoulder 522.

The second button 60 includes a shoulder 611 formed thereon between a first end and a second end. A seal 612 is put around the second end of the second button 60. The second end of the second button 60 extends to the exterior of the shower 30 through an aperture 332 defined in the porous cover 33. The second end of the second button 60 can be pressed. A spring 61 receives the first end of the second button 60. The spring 62 is compressed between the shoulder 611 and the seat 51 in order to return the second button 60 to the original position.

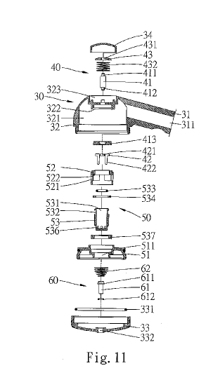

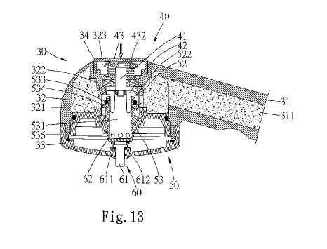

Referring to FIGS. 11 and 13, the button 43 is pressed. The pusher 42 is moved downwards. The pusher 42 pushes the valve 53 downwards. A gap occurs between the seal 533 and the shoulder 522. The water flows into the passageway 531 and thus pushes the valve 53 downwards. The water flows into a portion of the space 321 below the seat from the passageway 531 through the apertures 536. Through the apertures defined in the porous cover 33, the water comes out from the head 32 of the shower 30 instead of the first outlet 121 of the tap 10.

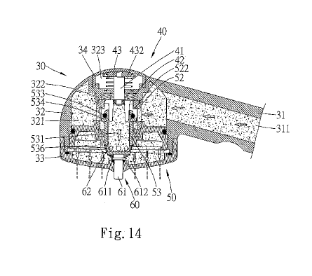

Referring to FIGS. 11 and 14, after the water starts to come out from the head 32 of the shower 30, the button 43 is released. The water continues to come out from the head 32 of the shower 30. A user can put the shower 30 on a holder (not shown) mounted on a wall (not shown). The user's hands are available for other tasks. This is convenient.

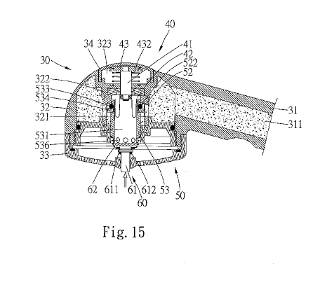

Referring to FIGS. 11 and 15, the second end of the second button 60 is inserted into the exterior of the shower 30 through an aperture 332 defined in the porous cover 33. The second end of the second button 60 is pressed. The first end of the second button 60 pushes the valve 53 upwards. The seal 533 contacts the shoulder 522 in order to stop the water from coming out from the head 32 of the shower 30.

The present invention has been described through the detailed illustration of the embodiments. Those skilled in the art can derive variations from the embodiments without departing from the scope of the present invention. Therefore, the embodiments shall not limit the scope of the present invention defined in the claims.

What is claimed is:

1. A shower apparatus comprising:
a shower comprising a handle defining a passageway and a head defining a space in communication with the passageway and a recess in communication with the space;
an outlet device that is put in the space and can be switched between a closed position and an open position and kept in the open position as long as water keeps coming; and
a control device extending into the space from the recess so that it can be operated in order to switch the outlet device to the open position from the closed position.

2. The shower apparatus according to claim 1 wherein the control device comprises a rod comprising a first end put in the recess in order to be pressed and a second end put in the space in order to switch the outlet device.

3. The shower apparatus according to claim 2 wherein the control device comprises a pusher connected to the second end of the rod in order to keep the second end of the rod in the space and switch the outlet device.

4. The shower apparatus according to claim 3 wherein the control device comprises a button connected to the first end of the rod.

5. The shower apparatus according to claim 4 comprising a flexible cap connected to the head for protecting the button.

6. The shower apparatus according to claim 1 wherein the outlet device comprises a valve for blocking the communication of the passageway with the space in the closed position and allowing the communication of the passageway with the space in the open position.

7. The shower apparatus according to claim 6 wherein the valve defines a passageway and a plurality of apertures communicated with the passageway.

8. The shower apparatus according to claim 7 wherein the outlet device comprises a seat put in the space in order to divide the space into a first portion and a second portion, wherein the seat defines an aperture through the valve is inserted so that the first portion thereof is in communication with the second portion thereof through the passageway and the apertures in the open position.

9. The shower apparatus according to claim 8 wherein the outlet device comprises a seal provided between the seat and the valve.

10. The shower apparatus according to claim 8 wherein the outlet device comprises a spring compressed between the seat and the valve for pushing the valve to the closed position.

11. The shower apparatus according to claim 10 wherein the outlet device comprise a ring put around the valve for contact with the spring.

12. The shower apparatus according to claim 8 comprising a porous cover for covering the space.

13. The shower apparatus according to claim 6 wherein the outlet device comprises a cage put in the space in order to enclose and guide the valve.

14. The shower apparatus according to claim 13 wherein the cage comprises a plurality of apertures through which water can flow to the valve.

15. The shower apparatus according to claim 13 wherein the cage comprises a shoulder formed on an internal side thereof for engagement with the valve in the closed position.

16. The shower apparatus according to claim 15 wherein the outlet device comprises a seal put around the valve for engagement with the shoulder in the closed position.

17. The shower apparatus according to claim 1 comprising a secondary control device extending to the exterior of the shower from the space so that it can be operated in order to switch the outlet device to the closed position from the open position.

18. The shower apparatus according to claim 17 wherein the secondary control device comprises a rod comprises a first end put in the space in order to push the outlet device to the closed position from the open position and a second end put outside the space in order to be pressed.

19. The shower apparatus according to claim 18 wherein the secondary control device comprises a spring for returning the rod to the original position when the rod is released.

20. The shower apparatus according to claim 19 wherein the rod comprises a shoulder for contact with the spring.
